(19) United States
(12) Patent Application Publication
(10) Pub. No.: US 2024/0039940 A1
(43) Pub. Date: Feb. 1, 2024

(54) LEARNING APPARATUS, LEARNING METHOD, ANOMALY DETECTION APPARATUS, ANOMALY DETECTION METHOD, AND COMPUTER-READABLE RECORDING MEDIUM

(71) Applicant: NEC Corporation, Minato-ku, Tokyo (JP)

(72) Inventors: Shohei Mitani, Tokyo (JP); Naoki YOSHINAGA, Tokyo (JP)

(73) Assignee: NEC Corporation, Minato-ku, Tokyo (JP)

(21) Appl. No.: 18/265,346

(22) PCT Filed: Dec. 14, 2020
(86) PCT No.: PCT/JP2020/046553

§ 371 Date: Jun. 5, 2023

(51) Int. Cl. H04L 9/40; H04L 41/16

(52) U.S. Cl. CPC H04L 63/1425; H04L 41/16

(57) ABSTRACT

A learning apparatus includes: a learning unit that learns a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

### TECHNICAL FIELD

The present invention relates to a learning apparatus and learning method for learning parameters that are used for mapping, and an anomaly detection apparatus and anomaly detection method for detecting anomalies based on the result of mapping, and further relates to a computer-readable recording medium that includes a program recorded thereon for realizing the learning apparatus, learning method, anomaly detection apparatus and anomaly detection method.

### BACKGROUND ART

In order to prevent attacks on control systems that are used in infrastructure, plants, buildings and the like, technologies for monitoring packets (e.g., packets including control commands, process values, control values, etc.) that flow through a network of the control system and detecting anomalous data generated by unauthorized control procedures have been disclosed.

As a related technology, Non-Patent Document 1 discloses a technology for separating the feature vectors of normal data and anomalous data, by mapping the feature vectors of normal data, out of input data, inside a hypersphere characterized by a center and a radius. With the technology of Non-Patent Document 1, a neural network is trained using Deep Support Vector Data Description (Deep SVDD), as much normal data as possible is fitted inside the hypersphere, and the volume of the hypersphere is minimized.

### LIST OF RELATED ART DOCUMENTS

### Non-Patent Document

Non-Patent Document 1: Lukas Ruff, et al., “Deep One-Class Classification”, July 2018, International Conference on Machine Learning 2018, pp. 4393-4402

### SUMMARY

### Technical Problems

However, when normal data and anomalous data are mapped using the technology shown in Non-Patent Document 1, a large amount of anomalous data may be mapped inside the hypersphere. One of the reasons why anomalous data is mapped inside the hypersphere is the system that is targeted having multiple states. Note that the system states also include a transitional state of transitioning between system states.

As one aspect, an example object is to provide a learning apparatus and learning method for learning parameters for mapping such that normal data and anomalous data are accurately separated, an anomaly detection apparatus and anomaly detection method for accurately detecting anomalies based on the result of mapping, and a computer-readable recording medium.

### Solution to the Problems

In order to achieve the example object described above, a learning apparatus according to an example aspect includes:
a learning unit that learns a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

Also, in order to achieve the example object described above, an anomaly detection apparatus according to an example aspect invention includes:
a mapping unit that inputs input data acquired from a target system to a mapping model, and mapping a feature vector generated based on the input data to a region set based on a subspace set in advance and a distance from the subspace; and
a determination unit that determines that a feature vector is anomalous based on a result of the mapping.

Also, in order to achieve the example object described above, a learning method according to an example aspect invention includes:
a learning step of learning a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

Also, in order to achieve the example object described above, an anomaly detection method according to an example aspect invention includes:
an inputting step of inputting input data acquired from a target system to a mapping model, and mapping a feature vector generated based on the input data to a region set based on a subspace set in advance and a distance from the subspace; and
a determining step of determining that a feature vector is anomalous based on a result of the mapping.

Also, in order to achieve the example object described above, a computer-readable recording medium according to an example aspect includes a program recorded on the computer-readable recording medium, the program including instructions that cause the computer to carry out:
a learning step of learning a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

Furthermore, in order to achieve the example object described above, a computer-readable recording medium according to an example aspect includes a program recorded on the computer-readable recording medium, the program including instructions that cause the computer to carry out:
an inputting step of inputting input data acquired from a target system to a mapping model, and mapping a feature vector generated based on the input data to a region set based on a subspace set in advance and a distance from the subspace; and
a determining step of determining that a feature vector is anomalous based on a result of the mapping.

### Advantageous Effects of the Invention

As one aspect, it is possible to mapping for accurately separate normal data and anomalous data, and to accurately detecting anomalies based on the result of mapping.

### BRIEF DESCRIPTION OF THE DRAWINGS

FIG. 1 is a diagram for describing an example of the learning apparatus.

FIG. 2 is a diagram for describing mapping of feature vectors.

FIG. 3 is a diagram illustrating an example of a system having the anomaly detection apparatus.

FIG. 4 is a diagram for describing an example of the operations of the learning apparatus.

FIG. 5 is a diagram for describing an example of the operations of the anomaly detection apparatus.

FIG. 6 is a diagram illustrating an example of a system having the anomaly detection apparatus.

FIG. 7 is a diagram for describing an example of the operations of the anomaly detection apparatus.

FIG. 8 is a diagram for showing an example of a computer that realizes the learning apparatus and the anomaly detection apparatus in example embodiment 1, example modification 1 and example embodiment 2.

### EXAMPLE EMBODIMENTS

First, an overview will be given in order to facilitate understanding of the example embodiments described below.

Systems (systems belonging to the same technical field) having a learning apparatus and an anomaly detection apparatus that are described in the example embodiments are used in order to monitor packets that flow through a network of a control system, in order to protect against attacks on the control system.

The learning apparatus generates a model that accurately separates and maps normal data and anomalous data that is generated by unauthorized control procedures. The anomaly detection apparatus detects anomalies using the model generated by the learning apparatus.

Conventionally, as a method for separating normal data and anomalous data, methods using an AE (Autoencoder), Deep SVDD, clustering and the like have been proposed.

With a method using an AE, there is a problem in that since separation of normal data and anomalous data depends on hyperparameters, the hyperparameters have to be tuned.

In view of this, in order to resolve the abovementioned problem with an AE, mapping for separating normal data and anomalous data using Deep SVDD shown in Non-Patent Document 1 has been proposed. However, with the method using Deep SVDD shown in Non-Patent Document 1, there is a problem in that since the feature vectors of anomalous data are mapped inside a hypersphere (normal region for fitting feature vectors of normal data), normal data and anomalous data cannot be accurately separated.

One of the reasons why the feature vectors of anomalous data are mapped inside a hypersphere is the control system having multiple system states during operation, and the behavior of the control system changing according to the system state.

(1) With the technology shown in Non-Patent Document 1, a neural network that maps different inputs to different points is used.

The reason for mapping to different points is that when mapping to the same point is allowed, the feature vectors of normal data and the feature vectors of anomalous data could possibly all be mapped to the same point, thus making the anomalous data undetectable.

(2) In the case where the control system has multiple system states, the input patterns also increase according to the system states, and thus the points to which normal data is mapped also increase with the increase in input patterns.

As such, due to (1) and (2), the radius of the hypersphere has to be increased, in order to fit the different points of the feature vectors of all the normal data in the hypersphere.

(3) With the technology shown in Non-Patent Document 1, learning is performed using normal data but learning is not performed using anomalous data, and thus points corresponding to the feature vectors of anomalous data are uniformly distributed throughout the entire space.

The result is that the feature vectors of the anomalous data that are uniformly distributed throughout the entire space due to (3) are likely to be mapped inside the hypersphere because of the radius of the hypersphere being increased due to (1) and (2).

Accordingly, in the case where there are multiple system states, it is difficult to accurately separate normal data and anomalous data, even using the technology shown in Non-Patent Document 1.

Note that, apart from the method described above, a method that combines clustering with the abovementioned method is also conceivable. However, the system states also include a transitional system state during the period of state transition.

As such, with a method that combines clustering, transitional normal data during state transition and normal data before and after state transition will be clustered as the same set, and thus multiple system states will be included in a single hypersphere, increasing the radius of the hypersphere, and making it difficult to accurately separate normal data and anomalous data.

Through such a process, the inventor found that there was a problem with conventional methods such as described above in that normal data and anomalous data cannot be accurately separated, and also derived means for resolving the related problems.

That is, the inventor derived a model that accurately separates and maps the feature vectors of normal data and the feature vectors of anomalous data in monitoring of a control system, and serves as a meaningful product that could not possibly be humanly created. The result is that anomalies that occur in a control system can be accurately detected, based on the result of mapping feature vectors using this model.

Hereinafter, example embodiments will be described with reference to the drawings. Note that, in the drawings described below, elements having the same functions or corresponding functions will be denoted by the same reference numerals, and repetitive description thereof may be omitted.

### Example Embodiment 1

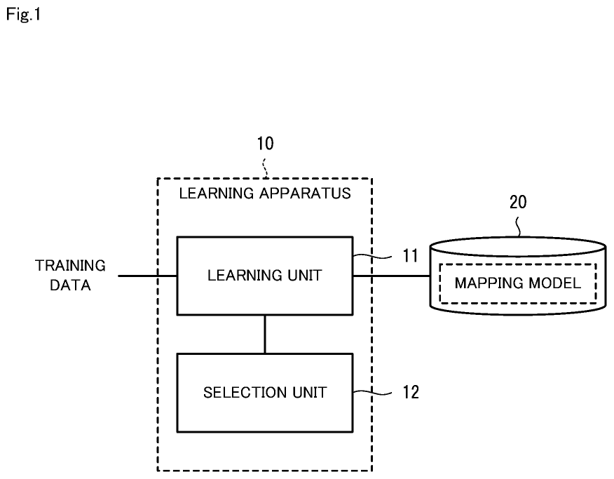

The configuration of a learning apparatus in an example embodiment 1 will be described using FIG. 1. FIG. 1 is a diagram for describing an example of the learning apparatus.

[Apparatus Configuration]

A learning apparatus 10 shown in FIG. 1 is an apparatus for learning a model for mapping the feature vectors of normal data and anomalous data acquired from a network of a control system to a subspace. Also, as shown in FIG. 1, the learning apparatus 10 includes a learning unit 11 and a selection unit 12.

The learning apparatus 10 is, for example, a programmable device such as a CPU (Central Processing Unit) or FPGA (Field-Programmable Gate Array), or a GPU (Graphics Processing Unit), or an information processing apparatus such as a circuit, server computer, personal computer or mobile terminal equipped with one or more thereof.

Data such as event series (traffic data) and time series (sensor data) flows through the network. Traffic data and sensor data may, for example, be stored in a storage device such as a database or a server computer, using a data collection device connected to the control system.

The control system is, for example, a system that is used in public or public interest utilities, facilities, structures and the like such as power plants, power grids, communication networks, roads, railways, ports, airports, water and sewage services, irrigation facilities and flood control facilities.

The event series represents the flow of a series of events that occur when the control system is used to perform control of a target. That is, the event series represents the order of events that occur when control of a target is performed. Events include control commands, state transition events and notification events, for example.

Traffic data is data that includes sets consisting of a packet and a reception date-time of the packet. A header field of the packet includes a source/destination MAC (Media Access Control) address, an IP (Internet Protocol) address, a port number and a version, for example. A payload of the packet includes an application type, an associated device ID, a control value and a state value, for example. The traffic data may also include statistics of the packet.

The time series represents the flow of a series of process values measured by a sensor. That is, the time series represents the order of process values that occur when a target is controlled. The process values are, for example, continuous values such as velocity, position, temperature, pressure and flow velocity, discrete values representing switching of a switch, and the like. Note that when process values are controlled with an unauthorized control procedure, the control system enters an anomalous state, and the process values will also be anomalous values.

Feature vectors are, for example, feature amounts, latent vectors, representation vectors, representations, embeddings, low-dimensional vectors, mappings to feature space, mappings to representation space, mappings to latent space (projections), and the like.

The learning unit 11 extracts the feature vectors of normal data from the training data and trains a mapping model that is used in order to map the feature vectors of normal data to a normal region. Thereafter, the learning unit 11 stores the trained mapping model in a storage device 20.

Specifically, the learning unit 11 first acquires subspace selection information relating to a subspace from the selection unit 12. Next, the learning unit 11 configures settings of the subspace and the like necessary for model learning, based on the subspace selection information, and ends the preparation for model learning.

The subspace is, for example, a hypersphere, a quadratic hypersurface (e.g., hyperellipsoid, hyper hyperboloid, etc.), a torus, or a hyperplane.

Alternatively, the subspace may be part of one of a hypersphere, a quadratic hypersurface, a torus, and a hyperplane.

Alternatively, the subspace may be a union that combines a plurality of one or more of a hypersphere, a quadratic hypersurface, a torus, and a hyperplane. Note that the union also includes a disjoint union (direct sum).

Alternatively, the subspace may be an intersection that combines a plurality of one or more of a hypersphere, a quadratic hypersurface, a torus, and a hyperplane.

The subspace selection information includes information representing the selected subspace. Information representing the selected subspace includes, for example, the number of dimensions of the selected subspace, the radius of a hypersphere, the coefficients of a quadratic hypersurface, the ellipticity of a hyperellipsoid, and affine transformation parameters that designate the slope of a hyperplane.

As the mapping model, a linear model, a neural network, a kernel model, a logistic model, probability distribution regression, stochastic process regression, a hierarchical Bayesian model, an RNN (Recurrent Neural Network), transformer or the like, for example, may be used. As the learning method, a generalized inverse matrix, a gradient descent method, the Monte Carlo method or the like, for example, may be used.

Next, learning is started when the preparation for model learning ends. The learning unit 11 acquires normal data input as training data.

As training data, data such as time series, audio, images, video, relational data (e.g., presence/absence or strength of friendship between people, presence/absence or strength of correlation between data, presence/absence of an inclusion relation, etc.) and behavior history, for example, may be used, apart from event series data.

Next, the learning unit 11 inputs the normal data input as training data to a model, generates feature vectors of the normal data, and trains a model for mapping the generated feature vectors of normal data to a normal region.

Specifically, the learning unit 11 generates, through learning, a first parameter and a second parameter that are included in the model and are respectively used in order to generate feature vectors and to adjust the distance from the subspace.

The normal region is a region that is set based on a subspace set in advance and the distance from the subspace (distance from the surface), and is derived through learning.

Mapping will now be described.

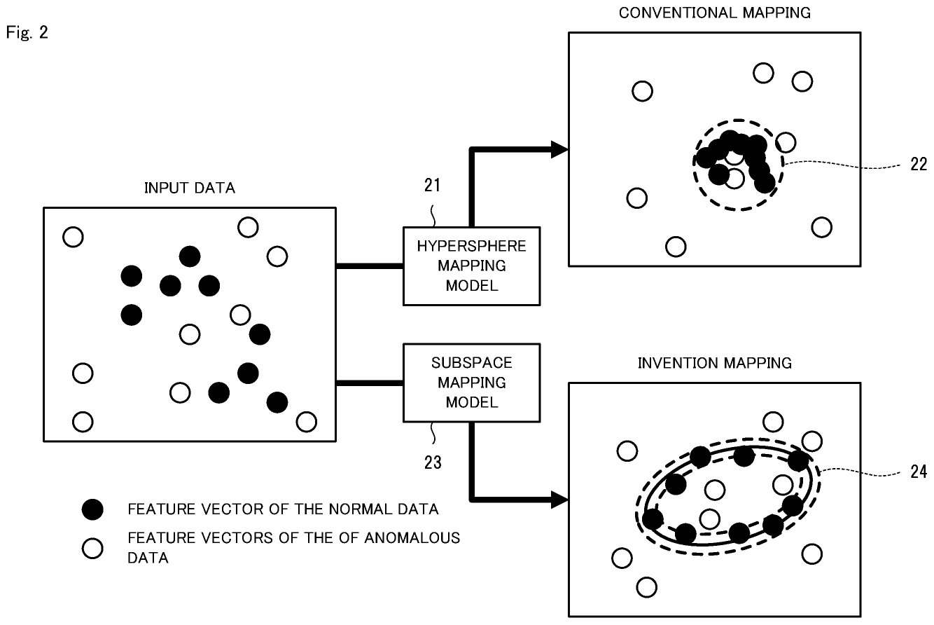

FIG. 2 is a diagram for describing mapping of feature vectors. First, conventional hypersphere mapping will be described. When the input data (traffic data) shown in FIG. 2 is input to a hypersphere mapping model 21 such as shown in Non-Patent Document 1, not only the feature vectors of normal data (black circles: ●) but also the feature vectors of anomalous data (white circles: ◯) are mapped inside a hypersphere 22 of FIG. 2.

Next, subspace mapping of the invention will be described. A subspace mapping model 23 shown in FIG. 2 is a model that, in the case where a torus is selected as the subspace, is trained using the selected torus. Further, in the case where, when the input data shown in FIG. 2 is input to the trained subspace mapping model 23, the input data is normal data, the feature vectors of the normal data (black circles: ●) are mapped to a normal region 24 (near the submanifold) in FIG. 2. In the case where the input data is anomalous data, the feature vectors of the anomalous data (white circle: ◯) are not mapped to the normal region 24.

The mapping model will now be described in detail.

In the case where a hypersphere is selected as the subspace, for example, the model can be represented by a loss function such as Equation 1. The subspace is, however, not limited to a hypersphere.

$$\begin{matrix}[ Equation 1 ] & \\ ℒ = {r}^{1} + \frac{1}{v} max ( {\vert \vert ϕ ( x ) - c \vert - R \vert}^{l} , 0 ) + ℒ uniform & ( 1 )\end{matrix}$$

$$ℒ uniform = {\vert 𝔼 [ \frac{ϕ ( x ) - c}{\vert ϕ ( x ) - c \vert} ] \vert}^{2}$$

$$ℒ : Loss function on hypersphere \\ x : Input data \\ ϕ ( x ) : Feature vectors of x ( learning parameter : first parameter ) \\ r : Distance from the subspace ( learning parameter : second parameter ) \\ c : Center point ( hyperparameter ) \\ R : Radius ( hyperparameter ) \\ l : Dimensional of distance ( hyperparameter ) \\ v : Ratio of learning rate of mapping to learning rate of distance from subspace ( hyperparameter ) \\ ℒ uniform : Auxiliary terms for dispersing feature vectors \\ 𝔼 : Mean of training data$$

The learning unit 11, through learning, learns a first parameter and a second parameter that are included in the loss function (model) of Equation 1 and are respectively used in order to generate feature vectors and to adjust the distance from the subspace.

Also, although the center point may be set in advance, the center point may also be learned as a third parameter.

In this way, the first parameter that is used in order to generate feature vectors, the second parameter that is used in order to adjust the distance of the normal region from the subspace, and the third parameter that designates part of the subspace can be set through learning, thus enabling the work involved in adjusting the parameters to be reduced.

Also, by providing an auxiliary term in the loss function of Equation 1, the feature vectors of normal data are dispersed so as to not be concentrated near the same point in the normal region.

The result is that, by using the generated model, it can be ensured that the feature vectors of normal data are evenly distributed in a direction that follows the subspace. Even when there is a large amount of different normal data, the feature vectors of the normal data can thereby be prevented from being distributed in a direction away from the subspace, and, as a result, the distance of the normal region from the subspace can be reduced. Accordingly, the feature vectors of normal data can be mapped to a very narrow normal region that follows the subspace, while the feature vectors of anomalous data can be mapped without following the subspace.

Also, when performing mapping with a hypersphere as the normal region as was conventionally the case, the volume of the hypersphere increased so as to fit the feature vectors of normal data into the hypersphere, and thus the feature vectors of anomalous data were also mixed together in the hypersphere.

However, by setting a subspace and the distance from the subspace as the normal region, the volume of the normal region can be reduced due to fitting the feature vectors of normal data within a small distance from the subspace and setting the normal region to be very narrow, thus ensuring that the feature vectors of anomalous data are unlikely to be mixed together in the normal region. That is, the feature vectors of normal data and the feature vectors of anomalous data can be accurately separated.

Also, because the feature vectors of normal data are mapped to a small volume normal region around a curved subspace such as a hypersphere or a quadratic hypersurface, the feature vectors of normal data in a transitional state connecting two normal states are easily separated from the feature vectors of anomalous data that are merely located between two normal states, based on the relationship between the normal region and the feature vectors of normal data and the relationship between the normal region and the feature vectors of anomalous data.

While the mapping of the feature vectors of anomalous data that are located between two normal states depends on the structure of the mapping model such as a neural network, these feature vectors are often mapped on a straight line (geodesic line) connecting two points on a curved subspace corresponding to the two normal states. Accordingly, the feature vectors of anomalous data that are located between two normal states will be mapped outside the normal region, rather than being mapped on the curved subspace.

The selection unit 12 selects a subspace such as described above. The selection unit 12 selects, as the subspace, at least one of a hypersphere, a quadratic hypersurface (e.g., hyperellipsoid, hyper hyperboloid, etc.), a torus, a hyperplane, part thereof, and a union or intersection thereof.

Specifically, first, a subspace for determining the normal region is selected. As the selection method, a method that involves getting the user to select the subspace by displaying a plurality of subspaces on a screen or the like is conceivable. Alternatively, a subspace suitable for the control system may be determined in advance through testing, simulation, machine learning, or the like.

Next, the selection unit 12 outputs subspace selection information to the learning unit 11, after one of the subspaces is selected by the user.

[System Configuration]

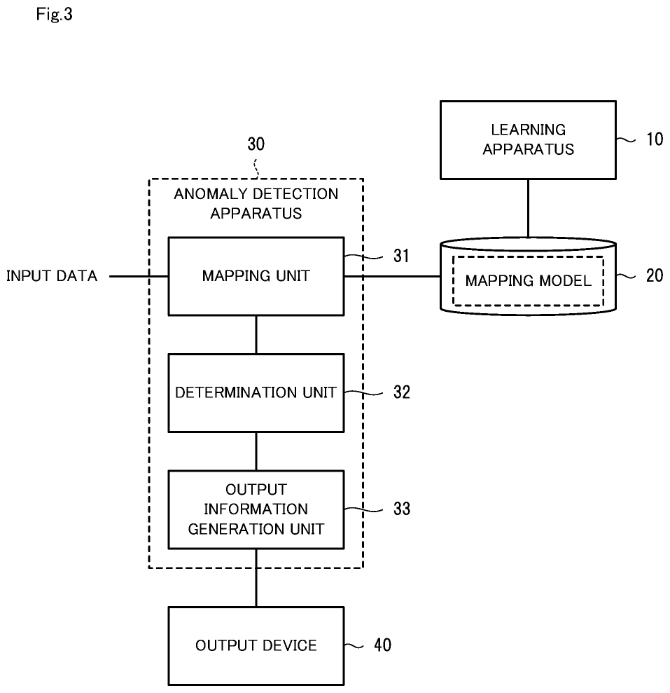

Next, the configuration of an anomaly detection apparatus 30 in the example embodiment 1 will be specifically described using FIG. 3. FIG. 3 is a diagram illustrating an example of a system having the anomaly detection apparatus.

As shown in FIG. 3, the system in the example embodiment 1 has the learning apparatus 10, the storage device 20, the anomaly detection apparatus 30, and an output device 40. The anomaly detection apparatus 30 has a mapping unit 31, a determination unit 32, and an output information generation unit 33.

The system will now be described.

Since the learning apparatus 10 and the storage device 20 have already been described, description thereof will be omitted.

The anomaly detection apparatus 30 is, for example, a programmable device such as a CPU or FPGA, or a GPU, or an information processing apparatus such as a circuit, server computer, personal computer or mobile terminal equipped with one or more thereof.

The output device 40 acquires output information described later that has been converted by the output information generation unit 33 into a format that can be output, and outputs generated images, audio and the like, based on the acquired output information. The output device 40 is, for example, an image display device that uses liquid crystals, organic EL (Electro Luminescence), or a CRT (Cathode Ray Tube). Further, the image display device may include an audio output device such as a speaker. Note that the output device 40 may be a printing device such as a printer.

The anomaly detection apparatus will now be described.

The mapping unit 31 inputs input data acquired from a target control system to a model and maps the feature vectors of the input data.

Specifically, the mapping unit 31 first acquires input data from a control system or storage device (not shown).

As input data, data such as time series, audio, images, video, relational data (presence/absence or strength of friendship between people, presence/absence or strength of correlation between data, presence/absence of inclusion relation, etc.), behavior history data and the like, for example, may be used, apart from event series and time series data.

Next, the mapping unit 31 inputs the input data to the mapping model and extracts feature vectors based on the trained mapping model. The feature vectors are represented with a set of n (1 or more) real numbers, for example.

Next, the mapping unit 31 outputs mapping result information representing the result of mapping to the determination unit 3. The mapping result is an image such as shown in the mapping of the invention in FIG. 2.

The mapping result information is information having identification information identifying the feature vectors of the respective input data, mapping position information representing the positions (points) of the feature vectors, and distance information representing the distance between the points and the normal region.

The determination unit 32 determines that a feature vector is anomalous based on the mapping result. Specifically, the determination unit 32 first acquires the mapping result information from the mapping unit 31.

Next, the determination unit 32 detects feature vectors mapped outside the normal region, based on the mapping result information. The determination unit 32 determines that feature vectors mapped to the normal region are the feature vectors of normal data, and determines that feature vectors mapped outside the normal region are the feature vectors of anomalous data, out of the extracted feature vectors.

Next, the determination unit 32 outputs determination result information having a determination result to the output information generation unit 33. The determination result information has information such as the feature vectors of input data and a determination result indicating whether the input data is normal or anomalous, for example. The determination result information may also include a log or the like, for example.

Also, the determination result may not only be the two values normal and anomalous, and a plurality of levels may be provided for anomalous.

Also, the determination unit 32 may further output the determination result information to another analysis engine.

The output information generation unit 33 acquires information such as determination result information and input data, and generates output information obtained by converting the acquired information into a format that can be output to the output device 40. The output information is information for causing the output device 40 to output at least a determination result.

(Example Modification 1)

An example modification 1 will now be described. In the example modification 1, another determination method of the determination unit 32 will be described.

The model for mapping feature vectors to the normal region is not necessarily a model actually trained using data acquired by operating a control system. Even in the case of a model trained using data acquired by operating a control system, there may be a large time lag between learning the model and operation utilizing the model. Furthermore, even if there is little time lag, the model could possibly be overtrained.

Thus, when mapping the feature vectors of data acquired from a control system during operation, error occurs in the positions of the feature vectors. That is, error also occurs in the distance between the normal region and the feature vectors.

In view of this, a threshold value that is used in order to absorb this error is set in advance. Specifically, the determination unit 32 compares the threshold value set in advance based on the normal region with the distance between the normal region and the feature vectors, and determines whether the distance is greater than or equal to the threshold value.

The threshold value may be derived through testing or simulation. For example, the threshold value is desirably set such that the false detection rate is not more than 1 [%]. The false detection rate is, however, not limited to 1 [%].

[Apparatus Operations]

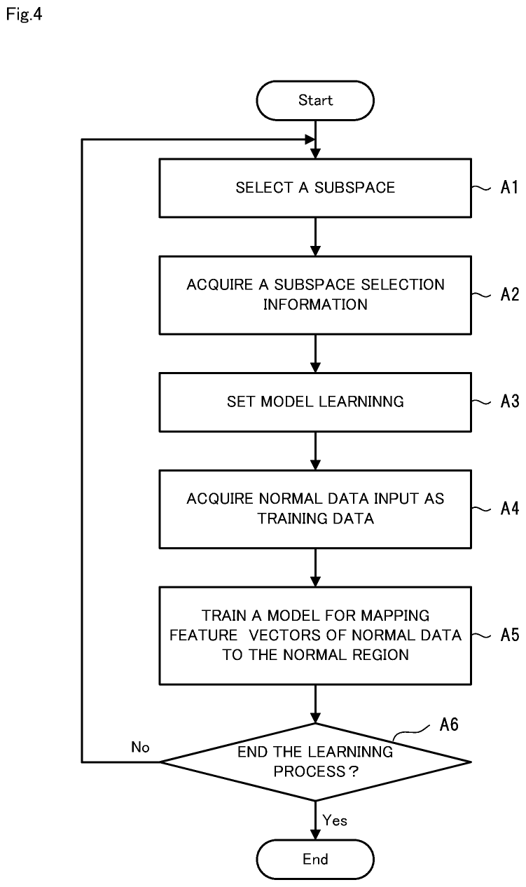

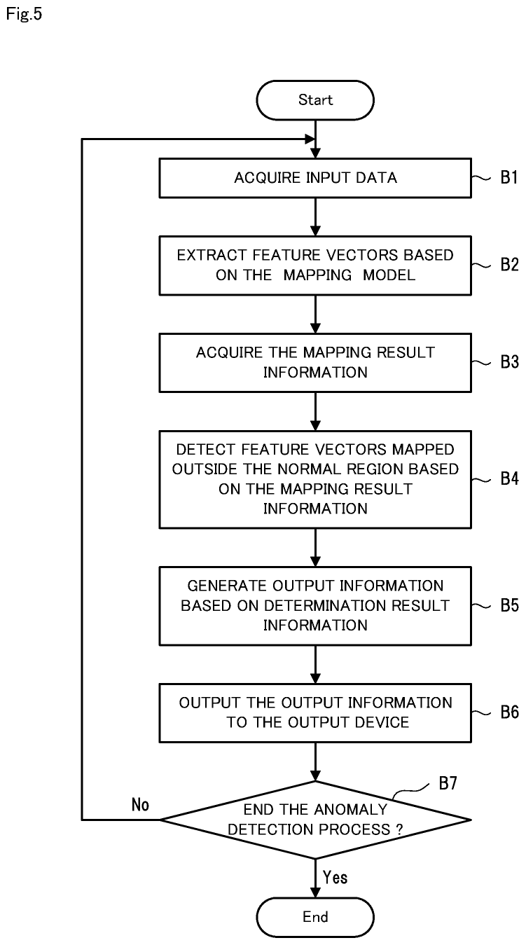

Next, operations of the learning apparatus and the anomaly detection apparatus in the example embodiment 1 will be described with reference to FIGS. 4 and 5. FIG. 4 is a diagram for describing an example of the operations of the learning apparatus. FIG. 5 is a diagram for describing an example of the operations of the anomaly detection apparatus. In the following description, the diagrams will be referred to as appropriate. Also, in the example embodiment 1, a learning method and an anomaly detection method are implemented by operating the learning apparatus and the anomaly detection apparatus. Therefore, the following description of the operations of the learning apparatus and the anomaly detection apparatus will be given in place of a description of the learning method and the anomaly detection method in the example embodiment 1.

The operations of the learning apparatus will now be described. As shown in FIG. 4, the selection unit 12 selects a subspace for determining the normal region (step A1). Specifically, in step A1, the selection unit 12 selects, as the subspace, at least one of a hypersphere, a quadratic hypersurface (e.g., hyperellipsoid, hyper hyperboloid, etc.), a torus, a hyperplane, part thereof or a union or intersection thereof, and outputs subspace selection information relating to the subspace.

Next, the learning unit 11 acquires the subspace selection information relating to the subspace from the selection unit 12 (step A2). Next, the learning unit 11 configures the settings of the subspace and the like necessary for model learning, based on the subspace selection information, and ends the preparation for model learning (step A3).

Next, learning is started when the preparation for model learning ends. The learning unit 11 acquires normal data input as training data (step A4).

Next, the learning unit 11 inputs the normal data input as training data to a model, generates feature vectors of the normal data, and trains a model for mapping the generated feature vectors of normal data to the normal region (step A5).

Specifically, in step A5, the learning unit 11 generates a first parameter and a second parameter that are included in the model and are respectively used in order to generate feature vectors and to adjust the distance from the subspace through learning.

Next, if an instruction to end the learning processing is acquired (step A6: Yes), the learning apparatus 10 ends the learning processing. If the learning processing is continued (step A6: No), the processing transitions to step A1 and is continued.

The operations of the anomaly detection apparatus will now be described.

As shown in FIG. 5, the mapping unit 31 acquires input data from a control system or storage device (not shown) (step B1).

Next, the mapping unit 31 inputs the input data to the mapping model and extracts feature vectors based on the trained mapping model (step B2). The feature vectors are represented, for example, by a set of n (1 or more) real numbers.

Next, the mapping unit 31 outputs mapping result information representing the result of mapping to the determination unit 3. The mapping result is an image such as shown in the mapping of the invention in FIG. 2.

Next, the determination unit 32 acquires the mapping result information from the mapping unit 31 (step B3). Next, the determination unit 32 detects feature vectors mapped outside the normal region, based on the mapping result information (step B4).

The determination unit 32 determines that feature vectors mapped to the normal region are the feature vectors of normal data, and feature vectors mapped outside the normal region are the feature vectors of anomalous data, out of the extracted feature vectors. The determination unit 32 outputs determination result information having a determination result to the output information generation unit 33.

Note that the determination unit 32 may determine the feature vectors of normal data and the feature vectors of anomalous data, based on the threshold value described in the example modification 1.

Also, the determination result may not only be the two values normal and anomalous, and a plurality of levels may be provided for anomalous.

Also, the determination unit 32 may further output the determination result information to another analysis engine.

Next, the output information generation unit 33 acquires information such as the determination result information and input data, and generates output information obtained by converting the acquired information into a format that can be output to the output device 40 (step B5). Next, the output information generation unit 33 outputs the output information to the output device 40 (step B6).

Next, if an instruction to end the anomaly detection processing is acquired (step B7: Yes), the anomaly detection apparatus 30 ends the anomaly detection processing. If the anomaly detection processing is continued (step B7. No), the processing transitions to step B1 and is continued.

[Effects of Example Embodiment 1]

According to the example embodiment 1 and the example modification 1 as described above, first and second parameters and a third parameter can be set through learning, thus enabling work related to adjustment of parameters to be reduced.

Also, by providing an auxiliary term in the loss function of Equation 1, the feature vectors of normal data are dispersed so as to not be concentrated near the same point in the normal region.

The result is that, by using the generated model, it can be ensured that the feature vectors of normal data are evenly distributed in a direction that follows the subspace. Even when there is a large amount of different normal data, the feature vectors of the normal data can thereby be prevented from being distributed in a direction away from the subspace, and, as a result, the distance of the normal region from the subspace can be reduced. Accordingly, the feature vectors of normal data can be mapped to a very narrow normal region that follows the subspace, while the feature vectors of anomalous data can be mapped without following the subspace.

Also, when performing mapping with a hypersphere as the normal region as was conventionally the case, the volume of the hypersphere increased so as to fit the feature vectors of normal data into the hypersphere, and thus the feature vectors of anomalous data were also mixed together in the hypersphere.

However, by setting a subspace and the distance from the subspace as the normal region, the volume of the normal region can be reduced due to fitting the feature vectors of normal data within a small distance from the subspace and setting the normal region to be very narrow, thus ensuring that the feature vectors of anomalous data are unlikely to be mixed together in the normal region. That is, the feature vectors of normal data and the feature vectors of anomalous data can be accurately separated.

Also, because the feature vectors of normal data are mapped to a small volume normal region around a curved subspace such as a hypersphere or a quadratic hypersurface, the feature vectors of normal data in a transitional state connecting two normal states are easily separated from the feature vectors of anomalous data that are merely located between two normal states, based on the relationship between the normal region and the feature vectors of normal data and the relationship between the normal region and the feature vectors of anomalous data.

[Program]

The program according to the example embodiment 1 and the example modification 1 of the present invention may be a program that causes a computer to execute steps A1 to A6 shown in FIG. 4 and/or may be a program that causes a computer to execute steps B1 to B7 shown in FIG. 5.

By installing this program in a computer and executing the program, the learning apparatus and the learning method or/and the anomaly detection apparatus and the anomaly detection method according to the present example embodiment can be realized. Further, the processor of the computer performs processing to function as the learning unit 11 and a selection unit 12, the mapping unit 31, the determination unit 32, and the output information generation unit 33.

Also, the program according to the present embodiment may be executed by a computer system constructed by a plurality of computers. In this case, for example, each computer may function as any of the learning unit 11 and a selection unit 12, the mapping unit 31, the determination unit 32, and the output information generation unit 33.

### Example Embodiment 2

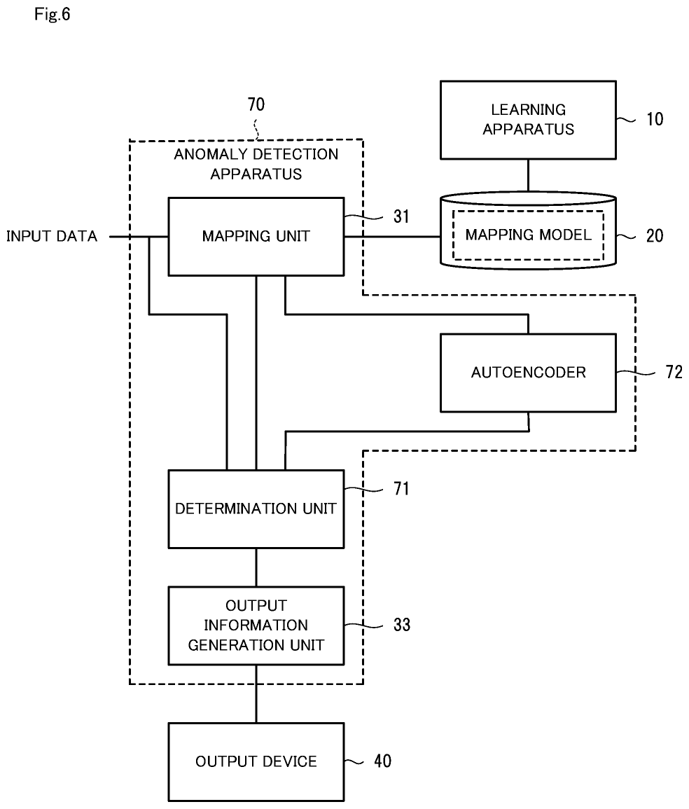

The configuration of an anomaly detection apparatus in an example embodiment 2 will be described using FIG. 6. FIG. 6 is a diagram illustrating an example of a system having the anomaly detection apparatus. In the example embodiment 2, an example using an autoencoder in anomaly detection will be described.

[System Configuration]

As shown in FIG. 6, the system according to the example embodiment 2 includes an anomaly detection apparatus 70, the learning apparatus 10, the storage device 20, and the output device 40. The anomaly detection apparatus 70 includes the mapping unit 31, the output information generation unit 33, a determination unit 71, and an autoencoder 72.

Note that the learning apparatus 10, the storage device 20, the output device 40, the mapping unit 31 and the output information generation unit 33 have already been described, and thus description thereof will be omitted.

The anomaly detection apparatus will now be described.

The determination unit 71 determines anomalies of feature vectors, using a reconstruction error in addition to the result of mapping.

Specifically, the determination unit 71 first acquires mapping result information from the mapping unit 31. Next, the determination unit 71 acquires reconstructed data corresponding to input data that is generated by inputting the feature vector of the input data to the autoencoder 72.

Next, the determination unit 71 generates reconstruction error information representing the difference between the input data and the data corresponding to the input data that is reconstructed from the feature vector of the input data.

The reconstruction error information is output as one or more real values, by calculating the squared error or the cross entropy, for example.

Next, the determination unit 71, similarly to the determination unit 32 described above (see example embodiment 1 and example modification 1), determines whether the input data is normal or anomalous, based on the result of mapping (first determination). Furthermore, the determination unit 71 determines whether the input data is normal or anomalous, according to the difference that is included in the reconstruction error information (second determination).

Next, if the first determination and the second determination are both normal, the determination unit 71 determines that the input data is normal. Also, if the first determination and the second determination are both anomalous, the determination unit 71 determines that the input data is anomalous. Furthermore, if either the first determination or the second determination is anomalous, the determination unit 71 determines that the input data is anomalous.

Alternatively, the determination unit 71, similarly to the determination unit 32 described above (see example embodiment 1 and example modification 1), calculates the weighted sum of the distance between the feature vector of input data and the subspace within the normal region and the difference that is included in the reconstruction error information, based on the result of mapping. The weighted sum represents the degree of anomaly of the input data.

Next, the determination unit 71, similarly to the abovementioned determination unit 32, sets an anomaly determination threshold value of the weighted sum in advance, and, if the weighted sum is lower than the threshold value, determines that the input data is normal. Also, if the weighted sum exceeds the threshold value, the determination unit 71 determines that the input data is anomalous.

Next, the determination unit 71 outputs determination result information having a determination result to the output information generation unit 33.

The autoencoder 72 trains by inputting the feature vectors of normal data in a learning phase. Also, the parameters generated by the training of the autoencoder 72 may be stored in a storage device provided in the anomaly detection apparatus 70 or in a storage device provided other than in the anomaly detection apparatus 70.

In the case where the autoencoder 72 is trained using the feature vectors of normal data, the autoencoder 72 is able to restore input data if the input data is normal data. In contrast, in the case where anomalous data is input to the autoencoder 72, the autoencoder 72 is not able to reflect the feature vectors of the anomalous data.

Accordingly, the input data and output data of the autoencoder 72 is compared, and if there is a large difference, it can be determined that there is anomalous data in the input data.

Note that training of the mapping model and training of the autoencoder 72 may be performed in parallel or may be performed separately.

[Apparatus Operations]

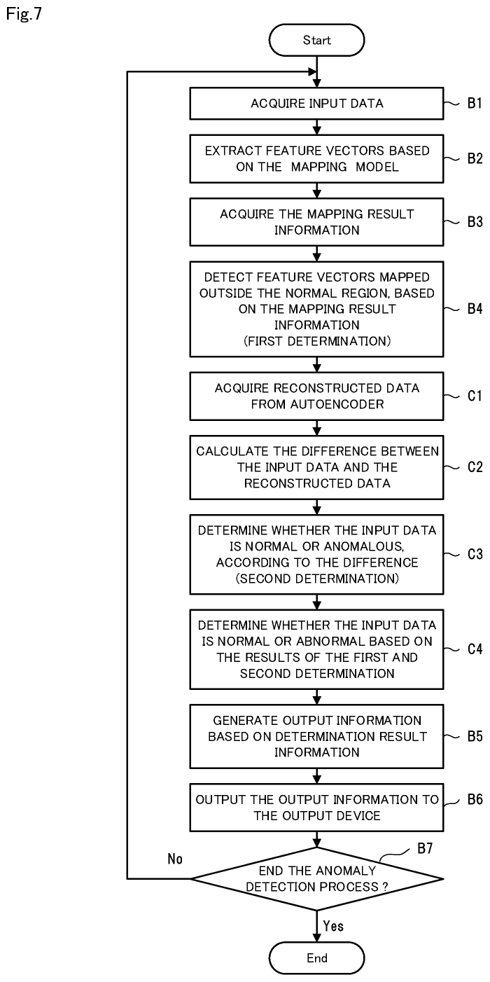

Next, the operations of the anomaly detection apparatus in the example embodiment 2 of the invention will be described with reference to FIG. 7. FIG. 7 is a diagram for describing an example of the operations of the anomaly detection apparatus. In the following description, the diagram will be referred to as appropriate. Also, in the example embodiment 2, an anomaly detection method is implemented by operating the anomaly detection apparatus. Therefore, the following description of the operations of the anomaly detection apparatus will be given in place of a description of the anomaly detection method in the example embodiment 2.

As shown in FIG. 7, the mapping unit 31 acquires input data from a control system or storage device (not shown) (step B1). Next, the mapping unit 31 inputs input data to the mapping model and extracts feature vectors based on the trained mapping model (step B2). Next, the mapping unit 31 outputs mapping result information representing the result of mapping to the determination unit 71.

Next, the determination unit 71 acquires the mapping result information from the mapping unit 31 (step B3). Next, the determination unit 71 detects a feature vector mapped outside the normal region, based on the mapping result information (step B4). Alternatively, the determination unit 71 calculates the distance from the subspace within the normal region to that feature vector.

The determination unit 71, similarly to the determination unit 32 described above (see example embodiment 1 and example modification 1), determines whether the input data is normal or anomalous, based on the result of mapping (first determination). The determination unit 71 outputs determination result information having a determination result to the output information generation unit 33.

Next, the determination unit 71 acquires reconstructed data corresponding to the input data that is generated by inputting the feature vector of the input data to the autoencoder 72 (step C1).

Next, the determination unit 71 generates reconstruction error information representing the difference between the input data and the data corresponding to the input data that is reconstructed from the feature vector of the input data (step C2).

Next, the determination unit 71 further determines whether the input data is normal or anomalous, according to the difference that is included in the reconstruction error information (second determination) (step C3).

Next, if the first determination and the second determination are both normal, the determination unit 71 determines that the input data is normal (step C4). Also, if the first determination and the second determination are both anomalous, the determination unit 71 determines that the input data is anomalous. Furthermore, if one of the first determination or the second determination is anomalous, the determination unit 71 determines that the input data is anomalous.

Alternatively, the determination unit 71 calculates the weighted sum of the distance from the subspace within the normal region to the feature vector of input data and the reconstruction error information representing the difference between data corresponding to the input data that is reconstructed from the feature vector of the input data. Furthermore, if the weighted sum exceeds a threshold value set in advance, the determination unit 71 determines that the input data is anomalous.

Next, the determination unit 71 outputs determination result information having a determination result to the output information generation unit 33.

Next, the output information generation unit 33 acquires information such as the determination result information and input data, and generates output information obtained by converting the acquired information into a format that can be output to the output device 40 (step B5). Next, the output information generation unit 33 outputs the output information to the output device 40 (step B6).

Next, if an instruction to end the anomaly detection processing is acquired (step B7: Yes), the anomaly detection apparatus 30 ends the anomaly detection processing. If the anomaly detection processing is continued (step B7: No), the processing transitions to step B1 and is continued.

[Effects of Example Embodiment 2]

According to the example embodiment 2 as described above, the accuracy of anomaly detection can, furthermore, be improved over the example embodiment 1.

Also, by assigning the task of reconstruction to an autoencoder, normal data having various states can be widely mapped to the subspace more clearly than in the example embodiment 1 according to the features. The result is a superior feature extractor.

[Program]

The program according to the example embodiment 2 of the present invention may be a program that causes a computer to execute steps B1 to B4, C1 to C4, and B5 to B7 shown in FIG. 7. By installing this program in a computer and executing the program, the anomaly detection apparatus and the anomaly detection method according to the present example embodiment can be realized. Further, the processor of the computer performs processing to function as the mapping unit 31, the determination unit 71, the output information generation unit 33, and the autoencoder 72.

Also, the program according to the present embodiment may be executed by a computer system constructed by a plurality of computers. In this case, for example, each computer may function as any of the mapping unit 31, the determination unit 71, the output information generation unit 33, and the autoencoder 72.

[Physical Configuration]

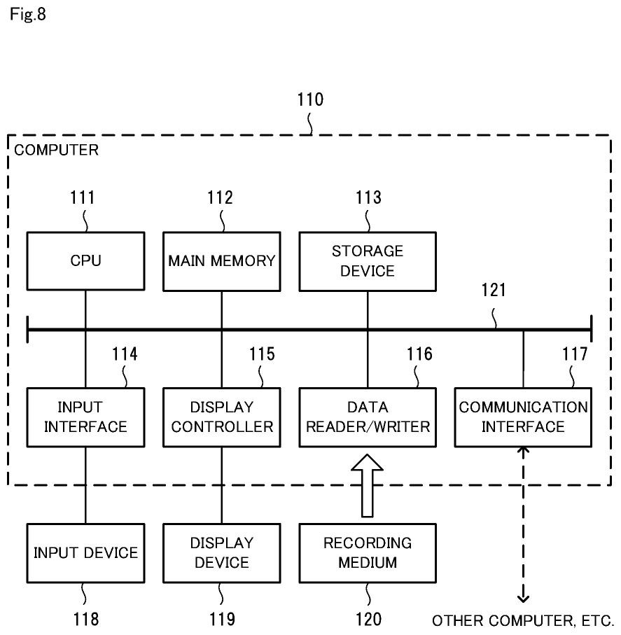

Here, a computer that realizes the learning apparatus and the anomaly detection apparatus by executing the program according to the example embodiment 1, the example modification 1, and the example embodiment 2 will be described with reference to FIG. 8. FIG. 8 is a block diagram showing an example of a computer that realizes the learning apparatus and the anomaly detection apparatus according to the example embodiment 1, the example modification 1, and the example embodiment 2.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the computer-readable recording medium 120 is anon-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the learning apparatus and the anomaly detection apparatus according to this example embodiment can also be realized by using hardware corresponding to each unit. Furthermore, a portion of the learning apparatus and the anomaly detection apparatus may be realized by a program, and the remaining portion realized by hardware.

[Supplementary Note]

Furthermore, the following supplementary notes are disclosed regarding the example embodiments described above. Some portion or all of the example embodiments described above can be realized according to (supplementary note 1) to (supplementary note 21) described below, but the below description does not limit the present invention.

### (Supplementary Note 1)

A learning apparatus comprising:
a learning unit that learns a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

### (Supplementary Note 2)

The learning apparatus according to supplementary note 1, comprising:
a selecting unit that selects, as the subspace, at least one of a hypersphere, a hyperellipsoid, a hyper hyperboloid, a torus, a hyperplane, part thereof, and a union or intersection thereof.

### (Supplementary Note 3)

The learning apparatus according to supplementary note 1 or 2, comprising:
an autoencoder for receiving input of a feature vector of the normal data and reconstructing input data corresponding to the feature vector.

### (Supplementary Note 4)

An anomaly detection apparatus comprising:
a mapping unit that inputs input data acquired from a target system to a mapping model, and mapping a feature vector generated based on the input data to a region set based on a subspace set in advance and a distance from the subspace; and
a determination unit that determines that a feature vector is anomalous based on a result of the mapping.

### (Supplementary Note 5)

The anomaly detection apparatus according to supplementary note 4,
wherein the determination unit determines that a feature vector mapped outside the region is anomalous.

### (Supplementary Note 6)

The anomaly detection apparatus according to supplementary note 4 or 5, comprising:
an autoencoder for receiving input of a feature vector of normal data and reconstructing input data corresponding to the feature vector,
wherein the determination unit calculates a reconstruction error representing a difference between the input data and reconstructed data obtained by inputting the feature vector of the input data to the autoencoder, and determines an anomaly of the feature vector, based on a result of the mapping and the reconstruction error.

### (Supplementary Note 7)

The anomaly detection apparatus according to any one of supplementary notes 4 to 6,
wherein the input data includes one of traffic data of a network in the system and sensor data output from a sensor.

### (Supplementary Note 8)

A learning method comprising:
a learning step of learning a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

### (Supplementary Note 9)

The learning method according to supplementary note 8, comprising:
a selecting step of selecting, as the subspace, at least one of a hypersphere, a hyperellipsoid, a hyper hyperboloid, a torus, a hyperplane, part thereof, and a union or intersection thereof.

### (Supplementary Note 10)

The learning method according to supplementary note 8 or 9, comprising:
an autoencoder step of, receiving input of a feature vector of the normal data and reconstructing input data corresponding to the feature vector.

### (Supplementary Note 11)

An anomaly detection method comprising:
a mapping step of inputting input data acquired from a target system to a mapping model, and mapping a feature vector generated based on the input data to a region set based on a subspace set in advance and a distance from the subspace; and
a determining step of determining that a feature vector is anomalous based on a result of the mapping.

### (Supplementary Note 12)

The anomaly detection method according to supplementary note 11,
wherein, in the determination step, a feature vector mapped outside the region is determined to be anomalous.

### (Supplementary Note 13)

The anomaly detection method according to supplementary note 11 or 12, comprising:
an autoencoder step of, receiving input of a feature vector of normal data and reconstructing input data corresponding to the feature vector,
wherein, in the determination step, a reconstruction error representing a difference between the input data and reconstructed data obtained by inputting the feature vector of the input data is calculated, and an anomaly of the feature vector is determined, based on the reconstruction error due to the reconstruction.

### (Supplementary Note 14)

The anomaly detection method according to any one of supplementary notes 11 to 13,
wherein the input data includes one of traffic data of a network in the system and sensor data output from a sensor.

### (Supplementary Note 15)

A computer-readable recording medium that includes a program recorded thereon, the program including instructions that cause a computer to carry out:
a learning step of learning a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

### (Supplementary Note 16)

The computer-readable recording medium according to supplementary note 15, the program including instructions that cause the computer to carry out:
a selecting step of selecting, as the subspace, at least one of a hypersphere, a hyperellipsoid, a hyper hyperboloid, a torus, a hyperplane, part thereof, and a union or intersection thereof.

### (Supplementary Note 17)

The computer-readable recording medium according to supplementary note 15 or 16, the program including instructions that cause the computer to carry out:
an autoencoder step of, receiving input of a feature vector of the normal data and reconstructing input data corresponding to the feature vector.

### (Supplementary Note 18)

A computer-readable recording medium that includes a program recorded thereon, the program including instructions that cause a computer to carry out:
a mapping step of inputting input data acquired from a target system to a mapping model, and mapping a feature vector generated based on the input data to a region set based on a subspace set in advance and a distance from the subspace; and
a determining step of determining that a feature vector is anomalous based on a result of the mapping.

### (Supplementary Note 19)

The computer-readable recording medium according to supplementary note 18,
wherein, in the determining step, a feature vector mapped outside the region is determined to be anomalous.

### (Supplementary Note 20)

The computer-readable recording medium according to supplementary notes 18 or 19, the program including instructions that cause the computer to carry out:
an autoencoder step of receiving input of a feature vector of normal data and reconstructing input data corresponding to the feature vector,
wherein, in the determining step, a reconstruction error representing a difference between the input data and reconstructed data obtained by inputting the feature vector of the input data is calculated, and an anomaly of the feature vector is determined, based on a result of the mapping and the reconstruction error.

### (Supplementary Note 21)

The computer-readable recording medium according to any one of claims 18 to 20,
wherein the input data includes one of traffic data of a network in the system and sensor data output from a sensor.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

As described above, according to the present invention, it is possible to mapping for accurately separate normal data and anomalous data, and to accurately detecting anomalies based on the result of mapping. The present invention is useful in fields where it is necessary to monitor of control systems.

### REFERENCE SIGNS LIST

10 Learning apparatus
11 Learning unit
12 Selection unit
20 Storage device
30 Anomaly detection apparatus
31 Mapping unit
32 Determination unit
33 Output information generation unit
40 Output device
70 Anomaly detection apparatus
71 Determination unit
72 Autoencoder
110 Computer
111 CPU
112 Main memory
113 Storage device
114 Input interface
115 Display controller
116 Data reader/writer
117 Communications interface
118 Input device
119 Display device
120 Recording medium
121 Bus

What is claimed is:

1. A learning apparatus comprising:
one or more memories storing instructions; and
one or more processors configured to execute the instructions to:
learn a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

2. The learning apparatus according to claim 1, comprising:
one or more processors is further configured to execute the instructions to select, as the subspace, at least one of a hypersphere, a hyperellipsoid, a hyper hyperboloid, a torus, a hyperplane, part thereof, and a union or intersection thereof.

3. The learning apparatus according to claim 1, comprising:
one or more processors is further configured to execute the instructions to receive input of a feature vector of the normal data and reconstructing input data corresponding to the feature vector.

4. An anomaly detection apparatus comprising:
one or more memories storing instructions; and
one or more processors configured to execute the instructions to:
input data acquired from a target system to a mapping model, and mapping a feature vector generated based on the input data to a region set based on a subspace set in advance and a distance from the subspace; and
determine that a feature vector is anomalous based on a result of the mapping.

5. The anomaly detection apparatus according to claim 4,
wherein one or more processors is further configured to execute the instructions to determine that a feature vector mapped outside the region is anomalous.

6. The anomaly detection apparatus according to claim 4, comprising:
one or more processors is further configured to execute the instructions to receive input of a feature vector of normal data and reconstructing input data corresponding to the feature vector,
wherein in the determination, calculate a reconstruction error representing a difference between the input data and reconstructed data obtained by inputting the feature vector of the input data to the autoencoder, and determine an anomaly of the feature vector, based on a result of the mapping and the reconstruction error.

7. The anomaly detection apparatus according to claim 4,
wherein the input data includes one of traffic data of a network in the system and sensor data output from a sensor.

8. A learning method comprising:
learning a first parameter and a second parameter that are included in a mapping model for mapping, to a region set based on a subspace set in advance and a distance from the subspace, a feature vector generated based on normal data input as training data, the first parameter being for generating the feature vector and the second parameter being for adjusting the distance.

9. The learning method according to claim 8, comprising:
selecting, as the subspace, at least one of a hypersphere, a hyperellipsoid, a hyper hyperboloid, a torus, a hyperplane, part thereof, and a union or intersection thereof.

10. The learning method according to claim 8, comprising:
receiving input of a feature vector of the normal data and reconstructing input data corresponding to the feature vector.

11. An anomaly detection method comprising:
inputting input data acquired from a target system to a mapping model, and mapping a feature vector generated based on the input data to a region set based on a subspace set in advance and a distance from the subspace; and
determining that a feature vector is anomalous based on a result of the mapping.

12. The anomaly detection method according to claim 11,
wherein, in the determination, a feature vector mapped outside the region is determined to be anomalous.

13. The anomaly detection method according to claim 11, comprising:
receiving input of a feature vector of normal data and reconstructing input data corresponding to the feature vector,
wherein, in the determination, a reconstruction error representing a difference between the input data and reconstructed data obtained by inputting the feature vector of the input data is calculated, and an anomaly of the feature vector is determined, based on a result of the mapping and the reconstruction error due to the reconstruction.

14. The anomaly detection method according to claim 11,
wherein the input data includes one of traffic data of a network in the system and sensor data output from a sensor.

15-21. (canceled)
